(19) United States
(12) Patent Application Publication
(10) Pub. No.: US 2003/0018740 A1
(43) Pub. Date: Jan. 23, 2003

(54) Contents sharing system and software program executed by devices of the system

(75) Inventors: Toshihiro Sonoda, Kawasaki (JP); Naoki Nishiguchi, Kawasaki (JP); Takuya Sakamoto, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/984,529

(22) Filed: Oct. 30, 2001

(30) Foreign Application Priority Data
Jul. 16, 2001 (JP) 2001-215035

(51) Int. Cl. G06F 15/167

(52) U.S. Cl. 709/214

(57) ABSTRACT

A contents sharing system for general purpose use is provided, in which devices share contents distributed via a network, and contents can be shared even among devices of private addresses. The contents sharing system comprises plural devices connected with each other via a network. Each of the devices includes storage means for storing contents, communication means for connecting to the network and process means for executing a software program. Each of the devices generates a communication packet containing an identifier unique to the device and information indicating whether a connection address of the device is a global address or a private address. When a first device having a private address obtains contents held by a second device that belongs to the contents sharing system and has a private address, a third device that belongs to the contents sharing system and has a global address works as a proxy for file transmission.

### BACKGROUND OF THE INVENTION

1. Field of the Invention

The present invention relates to a contents sharing system in which plural devices share digital contents such as music and pictures, and a software program executed by the devices.

2. Description of the Prior Art

As a method for plural devices such as computers connected via a network to share contents, it is common to provide a server that stores and manages contents files. Each of the devices (client) can access to the server for downloading desired contents.

If a plurality of local area networks (LANs) are connected with each other via the Internet, a contents sharing system over the LANs usually includes one or more servers storing and managing contents, so that each computer can access to the servers and download desired contents.

Meanwhile, in the MP3 file interchange system provided by NAPSTAR Company in USA, users can interchange MP3 format music data stored in hard drives of personal computers held by users, instead of downloading files stored in a server.

The contents sharing system in which users download files from a server has a disadvantage that a load of the server is heavy, and it is difficult to provide a comfortable contents sharing environment if many users access to a server simultaneously.

Furthermore, in the above-mentioned MP3 file interchange system, the files are stored in user's personal computers, but meta-information of the files is managed in a specific server. In addition, this system is realized by using a special software program adapted to a limited type of contents, so it is not for general purpose use.

### SUMMARY OF THE INVENTION

An object of the present invention is to provide a contents sharing system for general purpose use, in which devices share contents that are distributed via a network, and contents can be shared even among devices of private addresses. Another object is to provide a software program executed by the devices that constitute the system.

The present invention provides a contents sharing system comprising plural devices connected with each other via a network. Each of the devices includes storage means for storing contents, communication means for connecting to the network and process means for executing a software program. Each of the devices generates a communication packet containing an identifier unique to the device and information indicating whether a connection address of the device is a global address or a private address. When a first device having a private address obtains contents held by a second device that belongs to the contents sharing system and has a private address, a third device that belongs to the contents sharing system and has a global address works as a proxy for file transmission.

According to this structure, processes for storing contents, managing contents, transmitting contents and others are distributed to devices that belong to the contents sharing system. Therefore, the problem in the client-server system for contents sharing, which is a heavy load on one device (server), can be avoided. In addition, file sharing can also be realized among devices having private addresses if a device having a global address works as a proxy for file transmission.

The present invention also provides a software program executed by process means in a contents sharing system comprising plural devices connected with each other via a network. Each of the devices includes storage means for storing contents, communication means for connecting to the network and the process means for executing a software program. The software program comprises the steps of generating a communication packet containing an identifier unique to the device and information indicating whether a connection address of the device is a global address or a private address, and arranging a third device that belongs to the contents sharing system and has a global address to work as a proxy for file transmission when a first device having a private address obtains contents held by a second device that belongs to the contents sharing system and has a private address.

The software program is installed into plural devices such as personal computers so that processors (CPUs) thereof execute the program. Thus, the plural devices are connected with each other via a network, and thereby the contents sharing system explained above can be realized.

This software program preferably further comprises the step of refusing to work as the proxy for file transmission under a predetermined condition when the device is requested to work as the proxy for file transmission. The condition includes a case where the device is already working as a proxy for file transmission in another contents transmission process, for example.

In another embodiment, the software program preferably further comprises the step of letting another device that belongs to the contents sharing system and has a global address take over the role as the proxy for file transmission when the device working as the proxy for file transmission finishes transmission of a predetermined size of contents. Thus, when plural devices play a role as a proxy for file transmission, a process load of each of the devices can be reduced.

In still another embodiment, the software program preferably further comprises the step of performing a search process using an identifier unique to a device as a keyword when searching a specific device that belongs to the contents sharing system. Thus, a specific device can be easily searched using the same way and process as the contents search.

In still another embodiment, the software program preferably further comprises the steps of registering an identifier unique to a device as an identifier of an authorized or an unauthorized device for access, and rejecting an access from a specific device in accordance with the registered identifier.

In still another embodiment, each of the devices has a memory area for registering a group name to which the device belongs within the contents sharing system, and the software program further comprises the step of performing a search of contents held by the device if a group name contained in a search query packet from a device requesting a contents search matches a group name memorized in the memory area of the device.

In still another embodiment, a search query packet from a device requesting a contents search contains a group name and a password, and the software program further comprises the step of performing a search of contents held by the device after checking the group name and the password.

In still another embodiment, the software program preferably further comprises the steps of collecting group names within the contents sharing system in accordance with a designated condition, and outputting a list of group names obtained in the collecting step to a display.

### BRIEF DESCRIPTION OF THE DRAWINGS

FIG. 1 shows a structure of a contents sharing system according to an embodiment of the present invention.

FIG. 2 shows an example in which a device A joins the contents sharing system comprising devices B, C and D.

FIG. 3 is a flowchart showing a process executed by the device B that is connected with the device A, which joins the existing contents sharing system.

FIG. 4 shows an example of a communication packet structure that is transmitted and received by devices of the contents sharing system.

FIG. 5 shows an example of contents search within the contents sharing system.

FIG. 6 shows an example of the case where contents are interchanged between devices having private addresses.

FIGS. 7 and 8 show an example of exchanging a proxy.

FIG. 9 shows an example of a process for eliminating an access from a specific device using an identifier unique to the device.

FIG. 10 is a flowchart of a process for rejecting an access from a specific device using an identifier unique to the device.

FIG. 11 shows an example of contents search in the case where a search query packet contains a group name.

FIG. 12 is a flowchart showing an example of performing the contents search after checking a group name and a password contained in a search query packet.

### DESCRIPTION OF THE PREFERRED EMBODIMENTS

Hereinafter, the present invention will be explained more in detail with reference to embodiments and drawings.

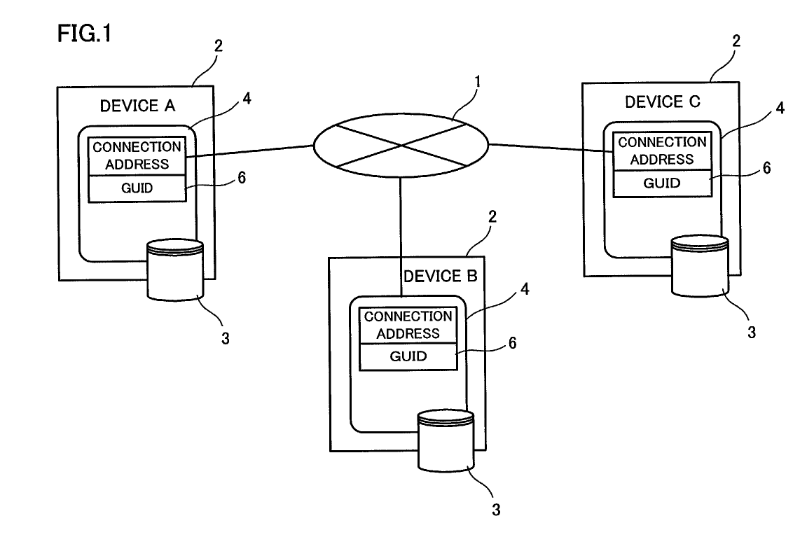

FIG. 1 shows a structure of a contents sharing system according to an embodiment of the present invention. The contents sharing system comprises a plurality of devices such as personal computers and a network connecting the devices with each other. Each of the devices 2 includes a storage device 3 for storing contents, a communication device for connecting to the network and a processor 4 that executes a software program for sharing contents, searching contents or other processes.

In the example shown in FIG. 1, the device A, the device B and the device C are connected with each other via the Internet 1. Each of the devices 2 is realized by installing a predetermined software program into a personal computer, for example. Each of the devices 2 has a built-in or an external storage device 3 storing contents that are shared with other devices (computers). A device (a computer) that joins the contents sharing system makes a connection with a device that constitutes the contents sharing system and has a known connection address (e.g. an IP address).

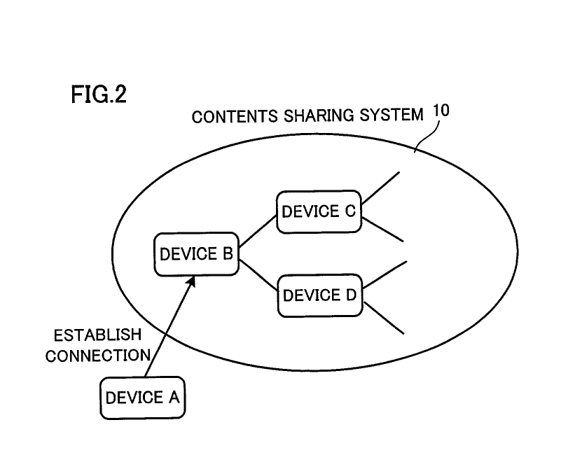

FIG. 2 shows an example in which the device A joins the contents sharing system 10 comprising the devices B, C and D. The device A tries to make a connection with the device B that belongs to the contents sharing system 10. It is assumed that the user of the device A knows a global address of the device B. In the contents sharing system 10, if the number of connections between the device B and other devices has not reached a preset value, the device B accepts the connection with the device A. If the number of connections has reached the preset value, the device B searches other devices whose number of connections has not reached the preset value. The preset value means a maximum number of other devices to which a device can connect for forming the contents sharing system 10.

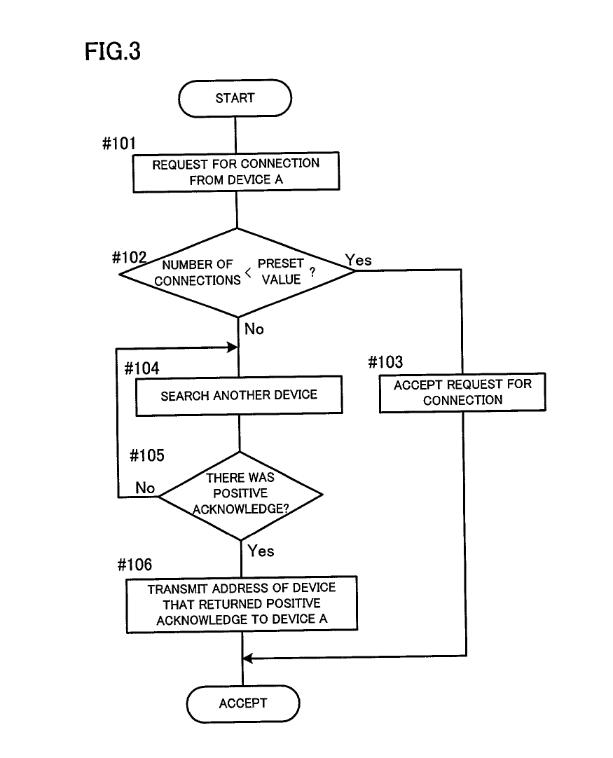

FIG. 3 is a flowchart showing a process executed by the device B that is connected with the device A, which joins the existing contents sharing system. The device B receives a request for connection from device A in Step #101 and checks whether the number of connections with other devices has reached the preset value in Step #102. If the number of connections has not reached the preset value, the device B accepts the request for connection in Step #103 so as to finish the connection. As a result, the device A can join the contents sharing system (Numeral 10 in FIG. 2).

If the number of connections has reached the preset value, the device B cannot accept the request for connection. Therefore, the device B searches a device whose number of connections has not reached the preset value among other devices that have already connected with the device B (the devices C and D in FIG. 2) (Step #104). Namely, the device B inquires of each device connected with the device B sequentially about whether the number of connections has reached the preset value. The device that received the inquiry returns the positive acknowledge to the device B if the number of connections has not reached the preset value.

In Step #105, it is checked whether there was the positive acknowledge or not. If there was the positive acknowledge, the address of the device that returned the positive acknowledge (e.g., the device C in FIG. 2) is transmitted to the device A (Step #106). As a result, the device A can make a connection with the device that returned the positive acknowledge so as to join the contents sharing system.

If there was not a positive acknowledge in Step #105, the process goes back to Step #104 for transmitting another inquiry to the next device (e.g., the device D in FIG. 2) about whether the number of connections has reached the preset value or not. If the number of connections has reached the preset value both in the device C and the device D, the search is performed in the next layer. Namely, the search process of the device B is taken over to the device C, which transmits inquiries sequentially to other devices connected to the device C (except the device B) about whether the number of connections has reached the preset value or not. Thus, tracing the connection hierarchy from the top layer to the bottom layers, a device whose number of connections has not reached the preset value is searched.

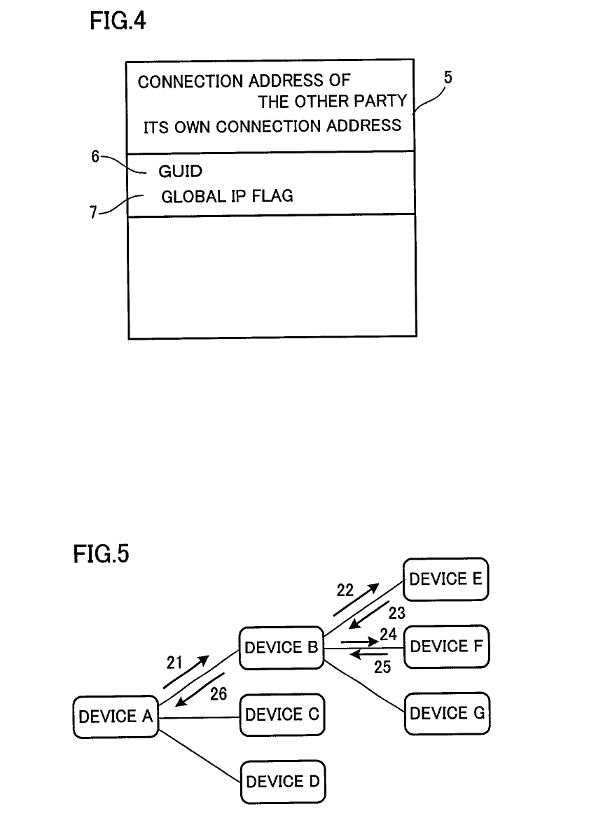

FIG. 4 shows an example of a communication packet structure that is transmitted and received by devices of the contents sharing system. The communication packet 5 contains a connection address of the other party, its own connection address, an identifier GUID (a global unique identifier) 6 that is unique to the device and a global IP flag 7 that indicates whether its own connection address is a global IP address or a private IP address.

The global IP address is unique to the device in the world and can be used as the Internet address. In contrast, the private IP address can work within an intranet of a company for example and cannot be used as the Internet address. In order to connect a device (e.g., a personal computer) having a private address with other device of the other network via the Internet for communication, it is necessary to convert the private address to the global address. Namely, a network address translation (NAT) process is necessary.

FIG. 5 shows an example of contents search within the contents sharing system. A device that has joined the contents sharing system can search specific contents using a keyword. In this example, first as shown by the arrow 21, the device A request a search query of contents to the device B. The search query contains a keyword necessary for the search. When receiving the search query, the device B checks whether the contents exist in the shared contents that the device B exhibits. The search method is not limited.

In the example of FIG. 5, the desired contents are not held in the device B, so the device B issues a similar search query to the device E (as shown by the arrow 22). After receiving the negative acknowledge (No) from the device E (as shown by the arrow 23), the device B issues a similar search query to the next device F (as shown by the arrow 24). In this way, each device issues a search query to other connecting devices sequentially. As a result, if the desired contents are found in the device F for example, the device F informs the device B of the positive acknowledge (Hit) (as shown by the arrow 25). Since this search query was issued from the device A, the device B informs the device A of the positive acknowledge (as shown by the arrow 26).

When downloading the found contents, if the connection address of the device F is a global address, the device A can access to the device F without difficulty and download desired contents from the device F. In this case, the connection address of the device A can be either a global address or a private address. Of course, if it is a private address, a router equipped with the NAT function is necessary between the device A and the device F. It is supposed that a device having a private address always satisfies this condition. Even if the address of the device F is a private address, the device F can make a connection with the device A if the device A has a global address. Thus, the connection between the device A and the device F is completed, and the device A can download contents from the device F.

However, if both the devices A and F have a private address individually, there is no method for connecting the device A with the device F directly. In this case, a device that has a global address and connects the device A with the device F indirectly works as a proxy.

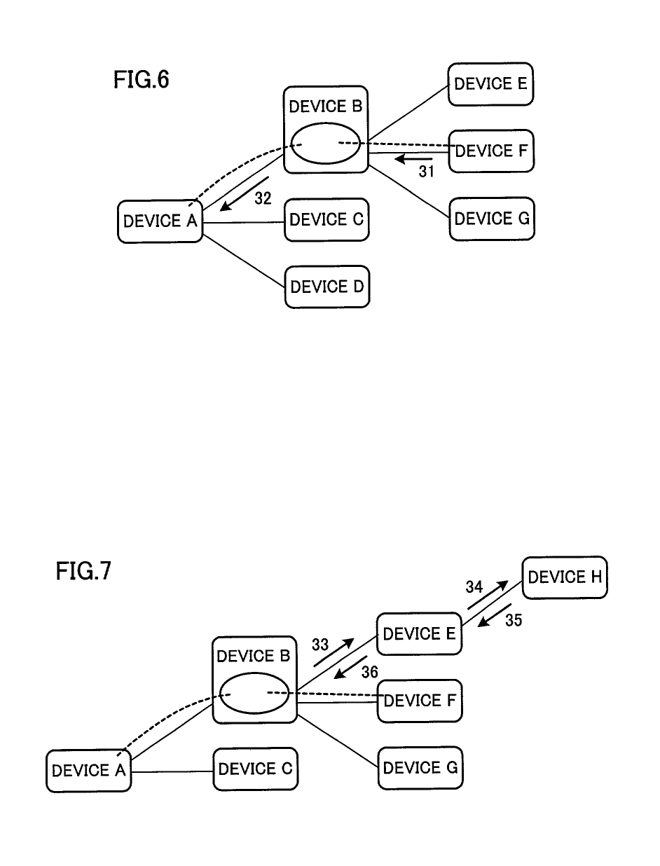

FIG. 6 shows an example of the case where contents are interchanged between devices having private addresses. After recognizing that the device A holds the desired contents, the device F checks whether the address of the device A is a global address or not. Namely, the device F checks the global IP flag 7 of the communication packet shown in FIG. 4. If the address of the device A is a private address and the address of the device F is a private address, the device F returns Hit+ (as shown by the arrow 31). This is a communication packet containing information that the contents were found by the search and a proxy is necessary for downloading the contents.

The device B receives the answer packet Hit+ first in the answering path and has a global address that is not working as a proxy. Therefore, the device B pass the answer packet Hit+ after adding information that the device B can work as a proxy and information for realizing the proxy work to the answer packet Hit+ (as shown by the arrow 32). The added information becomes a global IP address of the device that works as a proxy.

In the example of FIG. 6, the device B works as a proxy. The device A and the device F can be informed that the device B becomes a proxy as a result of the search query. The device B, as a proxy, passes the request for download from the device A to the device F and passes the contents downloaded from the device F to the device A without any process.

The device that has a global address and received the answer packet Hit+ can refuse to be a proxy under a predetermined condition. For example, if the device is working as a proxy for another download, or if the device is performing download or upload process, the device can refuse to be a proxy. Such a condition can be set by a user, or a predetermined condition can be memorized in the device in advance. When receiving the answer packet Hit+, the software program checks the state of itself and branches in accordance with the state.

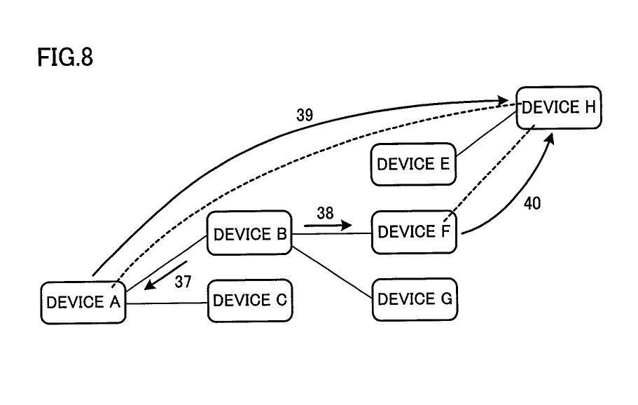

FIGS. 7 and 8 show an example of exchanging a proxy. In this example, the device B that was working as a proxy finishes the proxy role when a predetermined event occurs, e.g., when designated size of transmission finishes, and then passes the role to another device. For this process, the proxy device searches a device that can work as a proxy (performs proxy search) in the same way as the contents search. In the example of FIG. 7, the device B that was working as a proxy performs the proxy search toward the device E first (as shown by the arrow 33).

The device E receives a request packet of the proxy search and returns an OK packet if the device E can work as a proxy. In this example, however, the device E cannot work as a proxy. Therefore, the device E takes over the search and performs the proxy search toward the device H (as shown by the arrow 34). The device H can work as a proxy and returns the OK packet to the device E (as shown by the arrow 35). The device E receives the OK packet and passes it to the device B (as shown by the arrow 36).

As shown in FIG. 8, the device B receives the OK packet and issues a change proxy packet for instructing proxy change to the device A and the device F (as shown by the arrows 37 and 38). As a result, the device A and the device F disconnect themselves from the device B and make a connection with the device H again (as shown by the arrows 39 and 40), so as to continue the download from the device F to the device A using the device H as a proxy.

As shown in FIG. 4, the communication packet transmitted and received by the devices of the contents sharing system contains an identifier GUID 6 that is unique to the device. This identifier GUID 6 is used as a keyword for the search process, so that a specific device can be searched easily in the same way as the contents search. As shown in FIG. 2, the device joins the contents sharing system 10 first, and then performs the GUID search in the same way as the contents search. The search is performed sequentially until the device having the designated GUID is found.

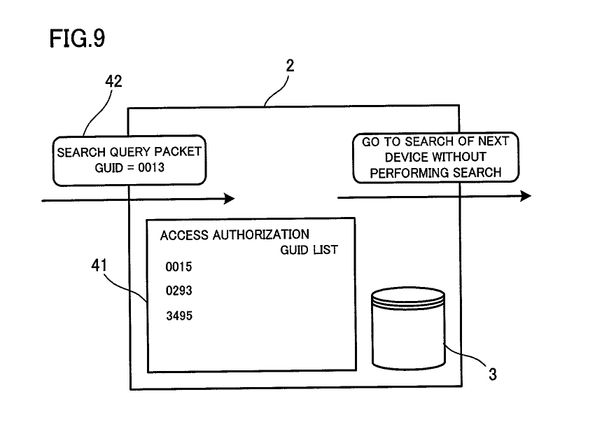

FIG. 9 shows an example of a process for eliminating an access from a specific device using an identifier unique to the device. The device has registered identifier of devices that can access or cannot access. Namely, the device has a memory area for memorizing a GUID list of devices whose accesses are accepted or rejected. In the example of FIG. 9, the device 2 memorizes a GUID list of devices whose accesses are accepted (an access authorization GUID list 41).

The device 2 performs the search of the shared contents if the identifier GUID contained in a search query packet 42 from the device that requests the contents search is registered in the access authorization GUID list 41. However, if the identifier GUID is not registered in the access authorization GUID list 41, the device 2 does not perform the search of the shared contents. In the example of FIG. 9, the identifier GUID=0013 contained in the search query packet is not registered in the access authorization GUID list 41, so the search process is not performed, and the process goes to a search of the next device. This process is similar to that when there is no matching in the search. A GUID list of devices whose accesses are rejected (an access rejection GUID list) can be memorized instead of the access authorization GUID list 41. In this case, if the identifier GUID contained in the search query packet 42 is not registered in the access rejection GUID list, the search of the shared contents is performed. Otherwise, the search is not performed, and the process goes to a search of the next device.

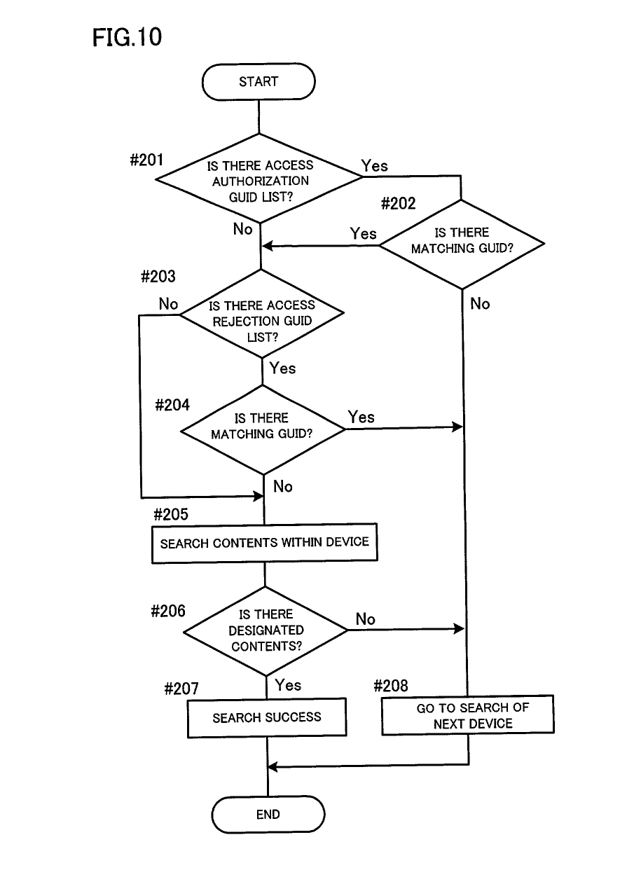

FIG. 10 is a flowchart of a process for rejecting an access from a specific device using an identifier unique to the device. After receiving the contents search query packet, the device checks whether there is an access authorization GUID list or not in Step #201. If there is the access authorization GUID list, it is checked whether an identifier GUID contained in the search query packet matches an identifier GUID registered in the access authorization GUID list (Step #202). If there is no matching, the search is not performed, and the process goes to a search of the next device (Step #208).

If there is not an access authorization GUID list in Step #201, or if there is a matching identifier GUID in Step #202, it is checked whether there is an access rejection GUID list or not in Step #203. If there is the access rejection GUID list, it is checked whether an identifier GUID contained in the search query packet matches an identifier GUID registered in the access rejection GUID list (Step #204). If there is a matching, the search is not performed, and the process goes to a search of the device (Step #208).

If there is not an access rejection GUID list in Step #203, and if the matching identifier GUID is not registered in Step #204, contents within the device are searched in Step #205. If the designated contents are found as a result (Yes in Step #206), the process finishes the search in success (Step #207). If the designated contents are not found (No in Step #206), the process goes to a search of the next device (Step #208).

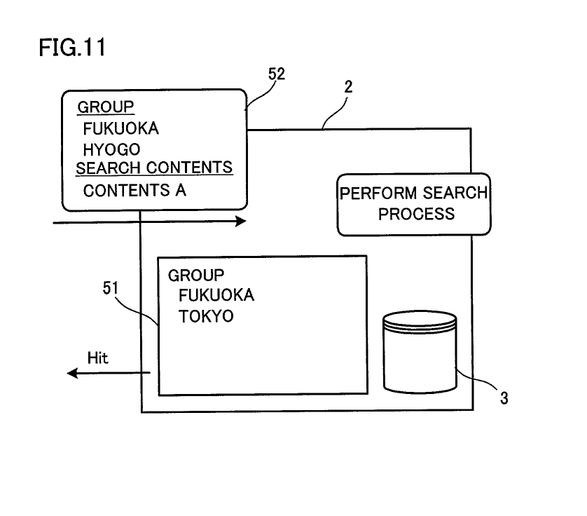

FIG. 11 shows an example of contents search in the case where the search query packet contains a group name. The device 2 includes a memory area 51 for memorizing a name of group to which the device 2 belongs within the contents sharing system. In addition, the search query packet 52 from the device that requests the contents search contains a group name (“FUKUOKA” and “HYOGO” in the example of FIG. 11). When receiving the search query packet 52, the device 2 checks whether a group name contained in the search query packet 52 matches a group name registered in the memory area 51. If there is a matching group name, the search process is performed. In the example of FIG. 11, the search process is performed since there is a matching group name “FUKUOKA”.

In addition, a password can be contained in the search query packet 52 adding to the group name. In this case, the device 2 checks the password corresponding to the matching group name and performs the search process if the password also matches.

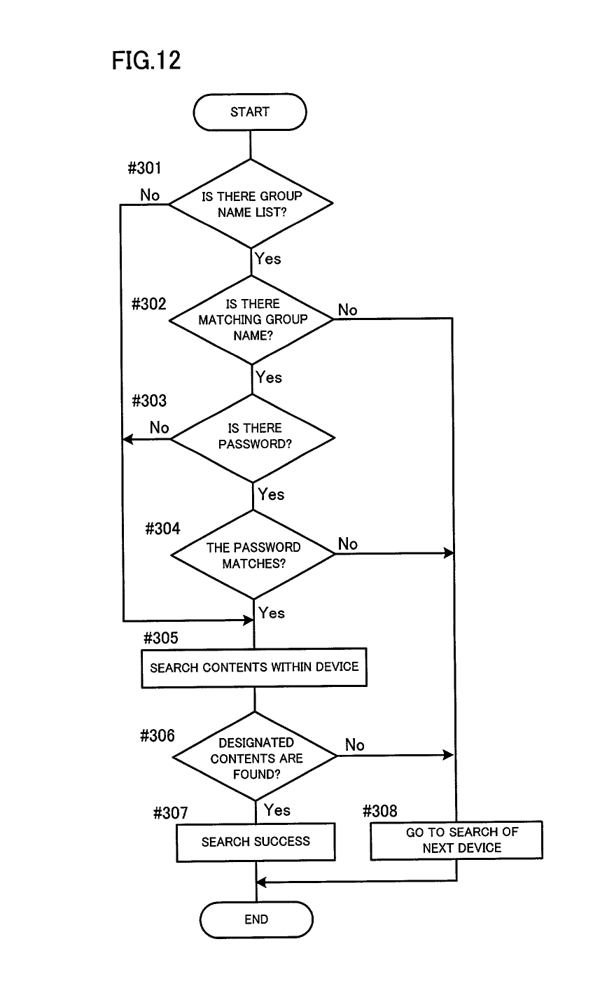

FIG. 12 is a flowchart showing an example of performing the contents search after checking a group name and a password contained in a search query packet. When receiving the contents search query packet, the device checks whether there is a group name list or not in Step #301. If there is not a group name list, the process goes to the search of contents (Step #305). If there is a group name list, it is checked whether a group name contained in the search query packet matches a group name registered in the group name list (Step #302). If there is no matching group name, the search is not performed, and the process goes to a search of the next device (Step #308).

If there is a matching group name in Step #302, it is checked whether there is a password or not in Step #303. If there is not a password, the process goes to the search of contents (Step #305). If there is a password, the password is checked in Step #304. If the password matches, the contents search is performed (Step #305). If the password does not match, the search is not performed, and the process goes to a search of the next device (Step #308).

After performing the search in Step #305, if the designated contents are found (Yes in Step #306), the process finishes the search in success (Step #307). If the designated contents are not found (No in Step #306), the process goes to a search of the next device (Step #308).

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A contents sharing system comprising plural devices connected with each other via a network, each of the devices including storage means for storing contents, communication means for connecting to the network and process means for executing a software program, wherein
each of the devices generates a communication packet containing an identifier unique to the device and information indicating whether a connection address of the device is a global address or a private address, and
when a first device having a private address obtains contents held by a second device that belongs to the contents sharing system and has a private address, a third device that belongs to the contents sharing system and has a global address works as a proxy for file transmission.

2. A software program executed by process means in a contents sharing system comprising plural devices connected with each other via a network, each of the devices including storage means for storing contents, communication means for connecting to the network and the process means, the software program comprising the steps of:
generating a communication packet containing an identifier unique to the device and information indicating whether a connection address of the device is a global address or a private address; and
arranging a third device that belongs to the contents sharing system and has a global address to work as a proxy for file transmission when a first device having a private address obtains contents held by a second device that belongs to the contents sharing system and has a private address.

3. The software program according to claim 2, further comprising the step of refusing to work as the proxy for file transmission under a predetermined condition when the device is requested to work as the proxy for file transmission.

4. The software program according to claim 2, further comprising the step of letting another device that belongs to the contents sharing system and has a global address take over the role as the proxy for file transmission when the device working as the proxy for file transmission finishes transmission of a predetermined size of contents.

5. The software program according to claim 2, further comprising the step of performing a search process using an identifier unique to the device as a keyword when searching a specific device that belongs to the contents sharing system.

6. The software program according to claim 2, further comprising the steps of registering an identifier unique to the device as an identifier of an authorized or an unauthorized device for access, and rejecting an access from a specific device in accordance with the registered identifier.

7. The software program according to claim 2, wherein each of the devices has a memory area for registering a group name to which the device belongs within the contents sharing system, and the software program further comprises the step of performing a search of contents held by the device if a group name contained in a search query packet from a device requesting a contents search matches a group name memorized in the memory area of the device.

8. The software program according to claim 2, wherein a search query packet from a device requesting a contents search contains a group name and a password, and the software program further comprises the step of performing a search of contents held by the device after checking the group name and the password.

9. The software program according to claim 7, further comprising the steps of collecting group names within the contents sharing system in accordance with a designated condition, and outputting a list of group names obtained in the collecting step to a display.

10. The software program according to claim 8, further comprising the steps of collecting group names within the contents sharing system in accordance with a designated condition, and outputting a list of group names obtained in the collecting step to a display.
